(19) United States
(12) Patent Application Publication
(10) Pub. No.: US 2026/0070193 A1
(43) Pub. Date: Mar. 12, 2026

(54) SOCKET WITH NUT CAPTURE

(71) Applicant: GEORGIA TECH RESEARCH CORPORATION, Atlanta, GA (US)

(72) Inventors: Stephen Balakirsky, Marietta, GA (US); Avi Balakirsky, Marietta, GA (US)

(21) Appl. No.: 19/327,192

(22) Filed: Sep. 12, 2025

Related U.S. Application Data
(60) Provisional application No. 63/693,942, filed on Sep. 12, 2024.

(51) Int. Cl. B25B 13/06; B25B 23/10

(52) U.S. Cl. CPC B25B 13/06; B25B 23/108

(57) ABSTRACT

A socket device includes a body defining a first aperture on the first end. A cavity extends into the body from the first aperture and is configured to receive a nut or bolt. A first channel extends perpendicular to the longitudinal axis of the body. The first channel is adjacent to the first end of the body extending between the inner surface and an outer surface of the body. A first retainer is disposed within the first channel. The first retainer includes a first end adjacent to the inner surface of the body that is biased radially inward towards the cavity. The first retainer is moveable between: (i) a first position wherein the first retainer extends into the cavity to retain the nut or bolt within the cavity; and (ii) a second position wherein the first retainer retracts radially outward to release the nut or bolt.

### CROSS-REFERENCE TO RELATED APPLICATIONS

This application claims priority to and the benefit of U.S. Provisional Ser. No. 63/693,942, filed on Sep. 12, 2024, the entire contents of which are incorporated herein by reference.

### GOVERNMENT LICENSES RIGHTS

This invention was made with government support under 80NSSC19K1052, awarded by National Aeronautics and Space Administration (NASA). The government has certain rights in the invention.

### BACKGROUND

A socket wrench is a type of wrench that uses separate, removable sockets to fit different sizes of nuts and bolts. The most prevalent form is the ratcheting socket wrench, often informally called a ratchet. A ratchet incorporates a reversible ratcheting mechanism that allows the user to pivot the tool back and forth to turn its socket instead of removing and repositioning a wrench to do so. Other common methods of driving sockets include pneumatic impact wrenches, hydraulic torque wrenches, torque multipliers, and breaker bars.

A principal advantage of interchangeable sockets is that, instead of a separate wrench for each of the many different fastener sizes and types, only separate sockets are needed for each size and type.

A standard socket for a socket wrench does not provide nut capture. There are some state-of-the-art magnetic sockets providing nut capture, but they only work with ferrous nuts and do not provide a mechanism for ejecting the captured nut (other than attaching it to another bolt).

There would be, therefore, a benefit to improving the socket for a socket wrench.

### SUMMARY

The exemplary socket is disclosed configured to additionally capture and release any types of nuts removed from a bolt. Rather than a standard socket that does not hold the nut or a magnetic socket that only works with a limited number of nut types, the exemplary socket can operate with any nut type and provides both a means for nut capture and release. The socket can also be used for socket head, screws with socket heads, and various connectors with socket heads.

Screw heads and nuts are prone to falling. In certain manufacturing environments, this can be particularly problematic as the presence of a loose nut, bolt, or screw in machinery can be problematic for the machine operation, while the retrieval of a loose nut or screw head can pose an equally problematic challenge in terms of its retrieval. An example of such an environment is in the fabrication of space equipment or vehicle components.

Also, during manufacturing operations with an autonomous robotic system, there is often the need to detach/attach nuts to bolts. The issue is that the nut must be first threaded onto the bolt for attachment and somehow gripped after removal. A standard socket head for a socket wrench does not provide nut capture. The exemplary device in utilizing a small spring plunger or a spring bar can provide for such a capture of the nut. Several different forms of the socket with different opening styles (matching commercial offerings) and different depths (again matching commercial offerings) are provided herein. Different mechanisms for nut ejection are also provided: first is assembled in the socket, and the other employs a cap to be attached. In addition to robotic applications, this tool will be useful for attaching a nut to any hard-to-reach bolt or in cases where dropping a nut is problematic.

According to one implementation, a socket device is disclosed. The socket device includes a body, a first channel, and a first retainer. The body includes a first end and a second end opposite and spaced apart from the first end along a longitudinal axis. The body defines a first aperture on the first end and a cavity at least partially defined by an inner surface of the body that extends from the first aperture. The cavity is configured to receive a nut or bolt. The first channel is defined by the body adjacent to the first end of the body. The first channel extends between the inner surface and an outer surface of the body in a direction substantially perpendicular to the longitudinal axis of the body. The first retainer is disposed within the first channel defined by the body. The first retainer includes a first end adjacent to the inner surface of the body. The first end of the first retainer is biased radially inward towards the cavity. The first retainer is moveable between: (i) a first position wherein the first end of the first retainer extends into the cavity to retain the nut or bolt within the cavity, and (ii) a second position wherein the first end of the first retainer retracts radially outward to release the nut or bolt from the cavity.

In some implementations, the second end of the body is couplable to a wrench.

In some implementations, the socket device has a form of a wrench.

In some implementations, the first retainer is a spring plunger.

In some implementations, the first retainer is a pressure tab extending into the cavity from a portion of the body and cantilevered therefrom.

In some implementations, the first retainer is a plunger, the socket further including a circumferential spring extending around the outer surface of the body and coupled to a second end of the plunger to bias the plunger radially inwards.

In some implementations, the first end of the first retainer includes an outer surface having one of a bull-nose shape, a polygonal shape, or a flat shape.

In some implementations, the socket device further includes a second channel defined by the body adjacent to the first end of the body and spaced apart circumferentially from the first channel. The second channel extends between the inner surface and the outer surface of the body in a direction substantially perpendicular to the longitudinal axis of the body. In some implementations, the socket device further includes a second retainer disposed within the second channel defined by the body. The second retainer includes a first end adjacent to the inner surface of the body. The first end of the second retainer is biased radially inward towards the cavity. The second retainer is moveable between: (i) a first position wherein the first end of the second retainer extends into the cavity to retain the nut or bolt within the cavity, and (ii) a second position wherein the first end of the second retainer retracts radially outward to release the nut or bolt from the cavity.

In some implementations, the first and second retainers are diametrically opposed across the cavity.

In some implementations, the first aperture has a hexagonal shape corresponding to a hexagonal cross-sectional shape of the cavity.

In some implementations, a cross-sectional shape of the cavity is round, rectangular, triangular, or hexagonal.

In some implementations, the socket device further includes an ejector disposed within the cavity adjacent to a second end of the cavity opposite from the first aperture. The ejector includes a first rod coupled to and extending from the ejector. The first rod extends through a first longitudinal opening defined between the inner surface and the outer surface of the body. The ejector is moveable towards the first end of the body to eject a nut or bolt retained in the cavity by the first retainer.

In some implementations, the ejector further including a second rod coupled to and extending from the ejector, the second rod being circumferentially spaced apart form the first rod. The second rod extends through a second longitudinal opening defined between the inner surface and the outer surface of the body.

In some implementations, the ejector further includes a spring disposed within the cavity and coupled to the ejector. The spring is configured to bias the ejector toward the second end of the body, wherein a force is applied to the first rod to move the ejector towards the first end of the body and eject the nut or bolt.

In some implementations, the socket device further includes a cap coupled to the first end of the body to retain the ejector within the cavity.

According to another implementation, a socket device is disclosed. The socket device includes a body, a cap, and a torsional spring. The body includes a first end and a second end opposite and spaced apart from the first end along a longitudinal axis. The body defines a first aperture on the first end. The body further defines a cavity at least partially defined by an inner surface of the body that extends from the first aperture. The cavity is configured to receive a nut or bolt. The body further includes a first coupler extending from an outer surface of the body. The cap is coupled to and freely rotatable about the body. The cap includes a sidewall extending around the outer surface of the body. A second coupler extends from an inner surface of the sidewall. The cap further includes an end surface defining a central aperture having a shape matching the first aperture of the body. The cap further includes a plurality of protrusions extending into the central aperture. Each of the plurality of protrusions includes a first surface and a second surface that are each sloped towards each other and angled relative to the end surface. The torsional spring is coupled between the first coupler of the body and the second coupler of the cap. The cap is biased by the torsional spring towards a offset position wherein the central aperture of the cap is misaligned with the first aperture and the cavity of the body. When a force is applied between a nut or bolt and the angled first surfaces of the plurality of protrusions, it enables rotation of the cap relative to the body until (i) the central aperture of the cap aligns with the first aperture of the body, and (ii) the nut or bolt is retained within the cavity of the body.

In some implementations, a force applied between the nut or bolt and the angled second surface of the plurality of protrusions enables rotation of the cap relative to the body until (i) the central aperture of the cap aligns with the first aperture of the body, and (ii) the nut or bolt is released from within the cavity of the body.

In some implementations, the second end of the body is couplable to a wrench.

In some implementations, a cross-sectional shape of the cavity is round, rectangular, triangular, or hexagonal.

In some implementations, the outer surface of the body includes a circumferential protrusion that is couplable with a ring channel defined by the inner surface of the sidewall of the cap, enabling rotation of the body relative to the cap.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The systems, methods, and devices are explained in even greater detail in the following drawings. The drawings are merely exemplary and certain features may be used singularly or in combination with other features. The drawings are not necessarily drawn to scale.

FIG. 1A shows a socket device, according to one implementation.

FIG. 1B shows a cross-sectional view of the socket device of FIG. 1A along line A-A.

FIG. 1C shows a cross-sectional view of the socket device of FIG. 1A along line B-B.

FIGS. 2A-2F show end views of various socket devices having differently shaped apertures and associated cavities, according to various implementations.

FIGS. 3A-3F show end views of various socket devices having differently arranged retainers and associated channels, according to various implementations.

FIG. 4A shows an assembly view of a socket device, according to one implementation.

FIG. 4B shows an assembled isometric view of the socket device of FIG. 4A.

FIG. 4C shows a phantom line view of the socket device of FIG. 4A revealing internal features.

FIG. 5A shows an assembly view of a socket device, according to one implementation.

FIG. 5B shows an assembled isometric view of the socket device of FIG. 5A.

FIG. 5C shows a phantom line view of the socket device of FIG. 5A revealing internal features.

FIG. 6A shows an isometric view of a socket device, according to one implementation.

FIG. 6B shows an end view of the socket device of FIG. 6A.

FIG. 6C shows a cross-sectional view of the socket of FIG. 6B along line A-A in FIG. 6B.

FIG. 7A shows an isometric view of a socket device, according to one implementation.

FIG. 7B shows an end view of the socket device of FIG. 7A.

FIG. 7C shows a cross-sectional view of the socket of FIG. 7B along line A-A in FIG. 7B.

FIG. 7D shows a cross-sectional view of the socket of FIG. 7B along line B-B in FIG. 7B.

FIG. 8A shows an isometric view of a socket device, according to one implementation.

FIG. 8B shows an end view of the socket device of FIG. 8A.

FIG. 8C shows a cross-sectional view of the socket of FIG. 8B along line A-A in FIG. 8B.

FIG. 9A shows an isometric view of a socket device, according to one implementation.

FIG. 9B shows an end view of the socket device of FIG. 9A.

FIG. 9C shows a cross-sectional view of the socket of FIG. 9B along line A-A in FIG. 9B.

FIG. 9D shows a cross-sectional view of the socket of FIG. 9B along line B-B in FIG. 9B.

FIG. 10A shows an isometric view of a socket device, according to one implementation.

FIG. 10B shows a phantom line view of the socket device of FIG. 10A, revealing internal features.

FIG. 10C shows an assembly view of the socket device of FIG. 10A.

FIG. 11A shows an isometric view of a socket device, according to one implementation.

FIG. 11B shows a phantom line view of the socket device of FIG. 11A, revealing internal features.

FIG. 11C shows an assembly view of the socket device of FIG. 11A.

FIG. 12A shows a disassembled and an assembled view of a circular ejector, according to one implementation.

FIG. 12B shows a disassembled and an assembled view of a circular ejector, according to one implementation.

FIG. 13A shows a disassembled and an assembled view of a hexagonal ejector, according to one implementation.

FIG. 13B shows a disassembled and an assembled view of a hexagonal ejector, according to one implementation.

FIG. 14A shows an isometric view of a socket device, according to one implementation.

FIG. 14B shows a bottom isometric view of the socket device of FIG. 14A.

FIG. 14C shows an assembly view of the socket device of FIG. 14A.

FIG. 14D shows another assembly view of the socket device of FIG. 14A.

FIG. 14E shows a cross-sectional view of the socket device of FIG. 14A along line A-A in FIG. 14A.

### DETAILED DESCRIPTION

Following below are more detailed descriptions of concepts related to, and implementations of, methods, apparatuses, and systems for a socket device configured for nut capture. The figures illustrate exemplary implementations in detail and the present disclosure is not limited to the details or methodology set forth in the description or illustrated in the figures. The terminology used herein is for the purpose of description only and should not be regarded as limiting.

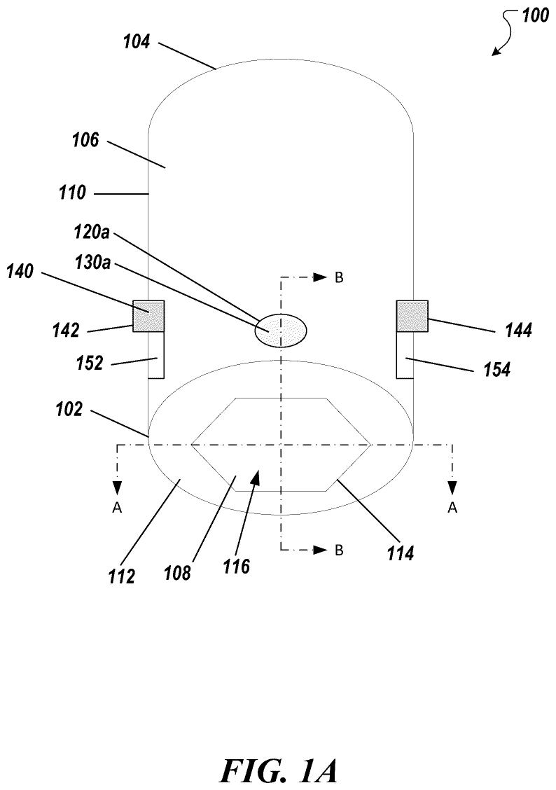

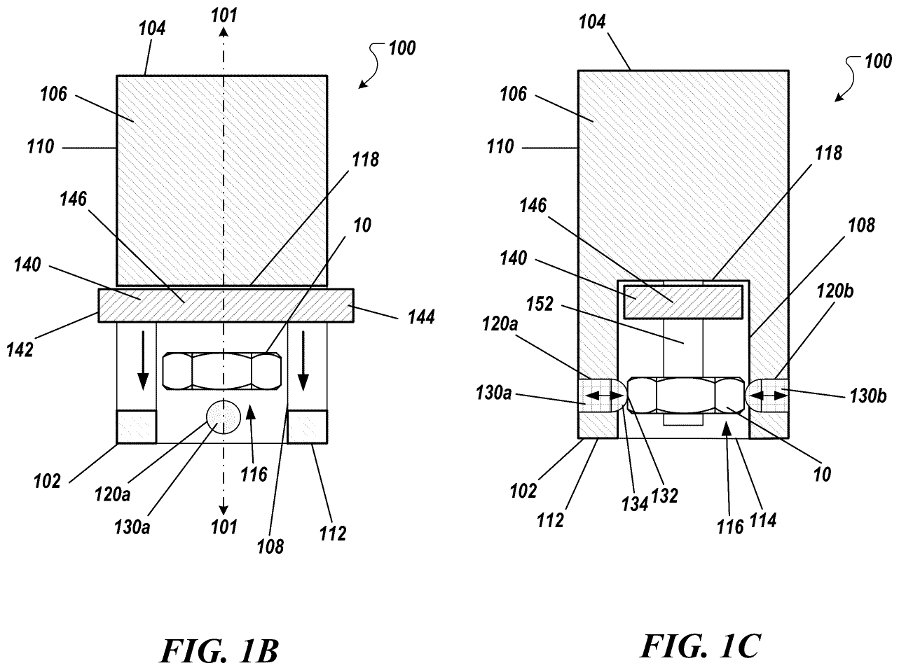

FIGS. 1A-1C show a socket device 100, according to one implementation. The socket device 100 includes a body 110, a first channel 120a, a second channel 120b, a first retainer 130a, a second retainer 130b, and an ejector 140, as further described below.

The body 110 of the socket device 100 extends from a first end 102 to a second end 104 opposite and spaced apart from the first end 102 along a longitudinal axis 101. The body 110 has a circular cross-sectional shape such that the body 110 is substantially cylindrical. However, in other implementations, the body may have a different overall shape and/or cross-sectional shape. The body 110 includes a metal or other rigid material. The second end 104 of the body 110 is couplable to a wrench or other tool for manipulating and operating the socket device 100. The body 110 generally has a size and shape configured to couple to a nut or bolt (e.g., the body can be sized up or down to accommodate standard or non-standard sizes, such as a ¼ inch, ½ inch, 10 mm, 1 inch, 20 mm, or other sized sockets and/or fasteners).

The body 110 includes an outer surface 106 extending between the first end 102 and the second end 104. The body 110 further includes an inner surface 108 that is spaced apart radially inward from the outer surface 106 of the body 110. The first end 102 of the body 110 includes a face 112 that is substantially perpendicular to the outer surface 106, the inner surface 108, and the longitudinal axis 101. The first end 102 of the body 110 defines a first aperture 114. More particularly, the face 112 on the first end 102 of the body 110 defines the first aperture 114.

Furthermore, the body 110 defines a cavity 116 extending longitudinally from the first aperture 114. More particularly, the cavity 116 is defined by the inner surface 108 of the body 110. The cavity 116 extends from the first aperture 114 to an end surface 118 extending perpendicularly to the face 112, the end surface 118 extending across the inner surface 108 to define an end of the cavity 116. The cavity 116 is configured to receive a nut or a portion of a bolt, such as the nut 10 shown in FIG. 1B and FIG. 1C. In other implementations, the cavity 116 may be referred to as a primary or main channel of the socket device.

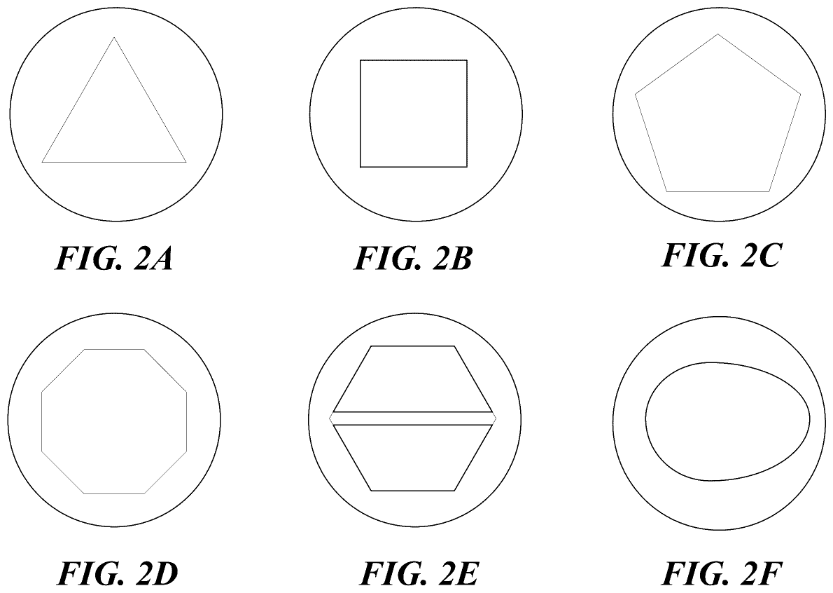

The cross-section shape of the cavity 116 and the shape of the first aperture 114 of the socket device 100 are both hexagonal, as shown in FIG. 1A. However, in other implementations, the first aperture and the cavity of the socket device may have a different shape. For example, FIGS. 2A-2F show end views of the first end of different bodies of a socket device, including a variety of different shapes for a first aperture and the corresponding cavity. For example, the cavity and/or the first aperture may have a triangular shape (e.g., in FIG. 2A), a square shape (e.g., in FIG. 2B), a pentagonal shape (e.g., in FIG. 2C), an octagonal shape (e.g., in FIG. 2D), or an irregular or off-center shape (e.g., in FIG. 2F). In some implementations, the first aperture may have more then one opening, such as the split hexagonal shape shown in FIG. 2E. The shape in FIG. 2E may be useful, for example, for a hexagonal nut or fastener having a channel for a flathead screwdriver, or other modified shapes of fasteners that can extend into distinct portions of the aperture and/or cavity.

Referring back to FIGS. 1A-1C, the body 110 of the socket device 100 further defines a first channel 120a and a second channel 120b. As shown in FIG. 1C, the first channel 120a and the second channel 120b extend between the outer surface 106 and the inner surface 108 of the body 110. In particular, the first channel 120a and the second channel 120b each extend substantially perpendicularly to the longitudinal axis 101 and/or the inner surface 108 of the body 110. The first channel 120a and the second channel 120b are therefore in communication with the cavity 116. The first channel 120a and the second channel 120b are disposed adjacent to, but spaced apart from, the face 112 on the first end 102 of the body 110. In other implementations, the first and second channels may extend at an angle relative to the longitudinal axis (e.g., angled slightly “upward”or “downward”from the perspective of FIG. 1C).

More generally, the first channel 120a and the second channel 120b are through-holes extending from the outer surface 106 to the inner surface 108 of the body 110. Thus, the first channel 120a and the second channel 120b have a circular cross-sectional shape. However, in other implementations, the channels may have a different cross-sectional shape (e.g., square or hexagonal). In other implementations, the channels may extend through the inner surface, but not the outer surface, of the body.

The first channel 120a is diametrically opposed to the second channel 120b (e.g., separated by 180 degrees relative to the longitudinal axis 101). However, in other implementations as further described herein, the channel(s) of the socket device may be separated by a different angle and/or orientation. Furthermore, while two channels are shown in the socket device 100, in other implementations further described herein, the socket device may include one channel or more than two channels.

The socket device 100 further includes a first retainer 130a and a second retainer 130b. The first retainer 130a is disposed within and retained by the first channel 120a. The second retainer 130b is disposed within and retained by the second channel 120b. The second retainer 130b is substantially similar in structure and function to the first retainer 130a such that like reference numbers denote like features.

The first retainer 130a includes a first end 132 adjacent to the inner surface 108 of the body 110. In particular, the first end 132 of the first retainer 130a includes a rounded or a bull-nose surface 134 extending into the cavity 116. In other implementations, the first end of the first retainer may have a different shape or surface, such as a flat surface or a polygonal shape. In other implementations, the first end of the first retainer may have a high-friction coating or surface. The first retainer 130a is a spring plunger wherein a spring (not explicitly shown) is disposed within the first retainer 130a. The spring biases the first end 132 and the bull-nose surface 134 of the first retainer 130a radially inward (e.g., towards the cavity 116 and/or the longitudinal axis 101). The second retainer 130b is similarly biased radially inward.

The first retainer 130a (and the second retainer 130b) are moveable between a first position and a second position. In the first position, the first end 132 and the bull-nose surface 134 of the first retainer 130a extend at least partially into the cavity 116 (e.g., radially inward) by, for example, a first distance. In the second position, the first retainer 130a (and the second retainer 130b) retract radially outward (e.g., away from the cavity 116) to be partially or fully disposed within the first channel 120a (and the second channel 120b). For example, in the second position, the first end 132 and the bull-nose surface 134 of the first retainer 130a may extend at least partially into the cavity 116 (e.g., radially inward) by, for example, a second distance that is smaller than the first distance.

As shown in FIG. 1C, the first retainer 130a and the second retainer 130b are configured to retain a nut or a bolt (e.g., the nut 10) within the cavity 116. More particularly, the first end 132 of the first retainer 130a (and the second retainer 130b) contacts a portion of the nut 10. Because the first retainer 130a and the second retainer 130b are spring loaded, they each impart a force on the nut 10 to retain the nut 10 in the cavity 116. In some implementations, the nut 10 may be retained between the first retainer 130a and the end surface 118 within the cavity 116. In other implementations, the nut 10 may extend further into the cavity 116 between the first and second retainers 130a, 130b and the end surface 118, first and second retainers 130a, 130b move or spring back to the first position after retracting to allow the nut 10 to pass. In some implementations, when the first retainer 130a is moved to the second position (e.g., radially outward), the nut 10 is released from the cavity 116 and able to exit the cavity 116 through the first aperture 114. For example, the nut 10 may fall downward through the first aperture 114, or the body 110 may be moved upward away from the nut 10, which may be engaged with a bolt or other fastener.

In other implementations, the first and second retainers 130a, 130b may be moved radially outward and into their respective channels 120a, 120b by the application of a downward force from the body 110 onto the nut 10. For example, a user may engage the body 110 with a nut 10, applying a force thereon. The bull-nose surface 134 of the first and second retainers 130a, 130b facilitate movement of the first and second retainers 130a, 130b radially outward such that the nut 10 can move into the cavity 116 to be retained by the first and second retainers 130a, 130b. In this way, the first and second retainers 130a, 130b move from the neutral first position to an engaged second position.

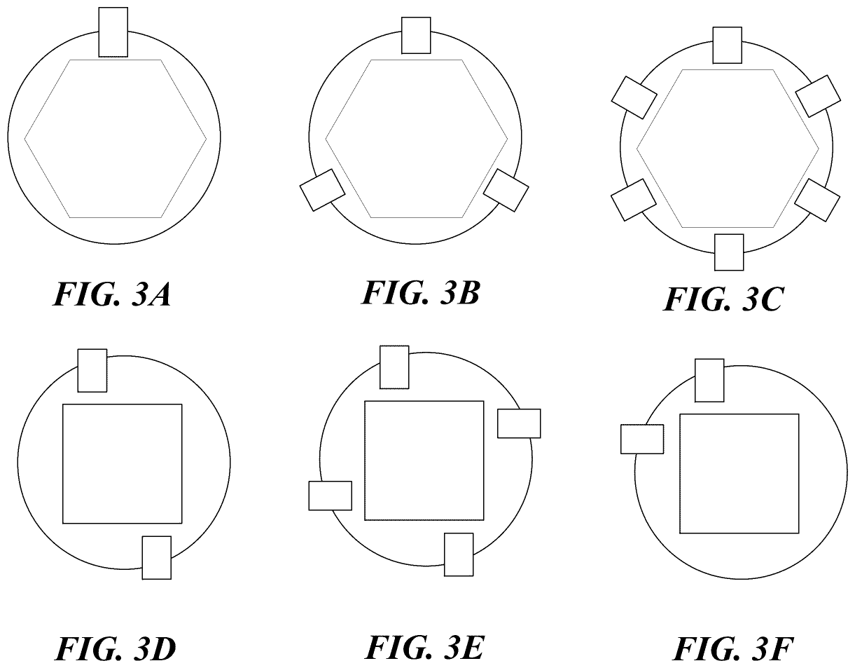

Although the first retainer 130a and the second retainer 130b of the socket device 100 are diametrically opposed from each other across the cavity 116, in other implementations the retainers have a different orientation and/or number. For example, FIGS. 3A-3F show different implementations of the retainers and corresponding channels for other versions of the socket device and the associated body. FIG. 3A shows a single retainer within a single channel on one side of a hexagonal cavity. FIG. 3B shows three retainers equally spaced around a hexagonal cavity. FIG. 3C shows six retainers equally spaced around a hexagonal cavity. FIG. 3D shows two retainers on opposing sides of a square cavity, wherein the retainers are offset from each other across the square cavity (e.g., misaligned relative to the longitudinal axis). FIG. 3E shows four retainers, one on each side of a square cavity, wherein the retainers are offset from each other across the square cavity. FIG. 3F shows two retainers on adjacent sides of a square cavity (e.g., next to each other on a corner of the cavity). Any combination, premutation, or re-orientation of the retainers and/or channels of FIGS. 3A-3F may be used with any of the other cavities and/or socket devices of the disclosure.

Referring back to FIGS. 1A-1C, the socket device 100 further includes an ejector 140. The ejector 140 is partially disposed within the cavity 116 adjacent to the end surface 118. In particular, the ejector 140 includes a central portion 146 disposed within the cavity 116. The central portion 146 of the ejector 140 may have a circular shape or another shape as further described herein. The ejector 140 further includes a first rod 142 and a second rod 144 each extending radially outwardly from the central portion 146 of the ejector 140. The first rod 142 is diametrically opposed to the second rod 144. However, in other implementations, the first and second rods are circumferentially spaced apart by a different angle or orientation.

The body 110 further defines a first longitudinal opening 152 and a second longitudinal opening 154 diametrically opposed to the first longitudinal opening 152. The first longitudinal opening 152 is defined between the first channel 120a and the second channel 120b. The second longitudinal opening 154 is defined on the opposite side between the second channel 120b and the first channel 120a. Both the first longitudinal opening 152 and the second longitudinal opening 154 extend through the body 110 from the inner surface 108 to the outer surface 106. Thus, both the first longitudinal opening 152 and the second longitudinal opening 154 are in communication with the cavity 116. The first longitudinal opening 152 and the second longitudinal opening 154 are spaced apart from the first end 102 and the face 112 of the body 110. The first longitudinal opening 152 and the second longitudinal opening 154 extend in a direction substantially parallel to the longitudinal axis 101 and the cavity 116.

The first rod 142 of the ejector 140 extends through the first longitudinal opening 152. The second rod 144 of the ejector 140 extends through the second longitudinal opening 154. The ejector 140 is moveable within the cavity 116 wherein the first and second rods 142, 144 are moveable along their respective first and second longitudinal openings 152, 154. For example, FIG. 1B shows the first rod 142 and the second rod 144 with direction arrows showing the ejector 140 moving away from the end surface 118 and towards the first end 102.

The ejector 140 is moveable to eject the nut 10 (or other fastener) from the cavity 116. In particular, once the nut 10 is retained within the cavity 116 by the first retainer 130a and the second retainer 130b, a force may be applied to facilitate disconnection between the socket device 100 and the nut 10. In particular, the ejector 140 is moved “downward” in the cavity 116 to contact and move the nut 10 towards the first end 102 of the body 110 and out of the first aperture 114. This action allows the first retainer 130a and the first retainer 130a to disengage from the nut 10 and return to their natural spring position (e.g., the first position). The first rod 142 and the second rod 144 function as actuation points wherein a user or device can force the ejector 140 to move within the cavity 116. In use, the user or a device can apply a force to the first rod 142 and/or the second rod 144 to move the ejector 140 and eject the nut 10 from the cavity 116. For example, once a nut 10 is retained by the socket device 100 and inserted onto a fastener or a desired position, the ejector 140 can be used to disengage the socket device 100 from the nut 10.

In other implementations described herein, the ejector may be spring loaded. For example, a spring may be disposed within the body and/or the cavity. The spring (not shown) may be coupled to the ejector and bias the ejector towards the end surface of the cavity. In such an implementation, the ejector naturally sits away from the retained nut, and a force opposed to the spring is required to eject the nut.

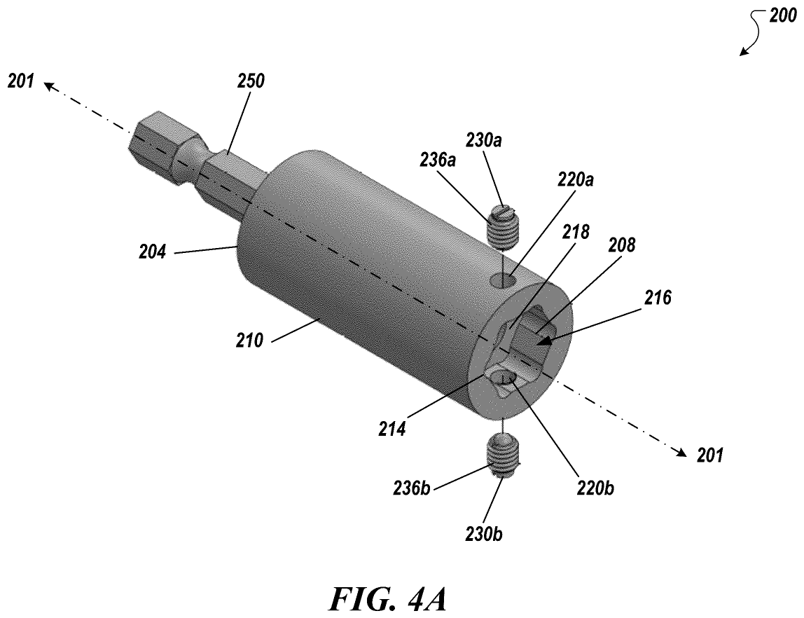

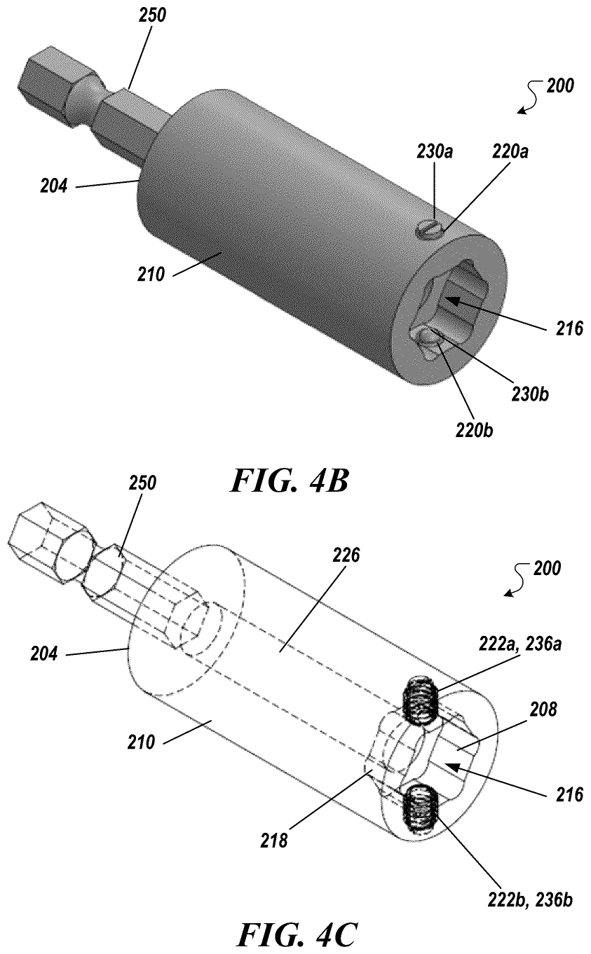

FIGS. 4A-4C show another implementation of a socket device 200. The socket device 200 is substantially similar to the socket device 100 except as described below. The second end 204 of the body 210 of the socket device 200 includes a shank 250. The shank 250 is couplable to a wrench, socket wrench, drill, or other tool configured to engage with and rotate the socket device 200 (e.g., via ratcheting motion).

The cavity 216 defined by the inner surface 208 of the body 210 has a substantially hexagonal cross-sectional area. The cavity 216 extends from the first aperture 214 to the end surface 218. Furthermore, an inner channel 226 extends from the end surface 218 towards the second end 204 of the socket device 200 (e.g., all the way along the body 210 along the longitudinal axis 201). The inner channel 226 is configured to provide passage for a bolt or other fastener having a long shaft when engaging with a nut 10. Thus, the bolt or fastener does not interfere with the end surface 218 or other portions of the body 210.

The first retainer 230a and the second retainer 230b of the socket device 200 are inserted into and retained within the first channel 220a and the second channel 220b of the body 210. The first and second retainers 230a, 230b have a threaded outer surface 236a, 236b. Furthermore, the first and second channels 220a, 220b have a threaded inner surface 222a, 222b. Thus, the first retainer 230a is threaded into the first channel 220a, and the second retainer 230b is threaded into the second channel 220b. To facilitate insertion and/or removal of the first retainer 230a and the second retainer 230b from the respective channels 220a, 220b, the outer surface of the first and second retainers 230a, 230b includes a drive engageable with a screwdriver or other tool.

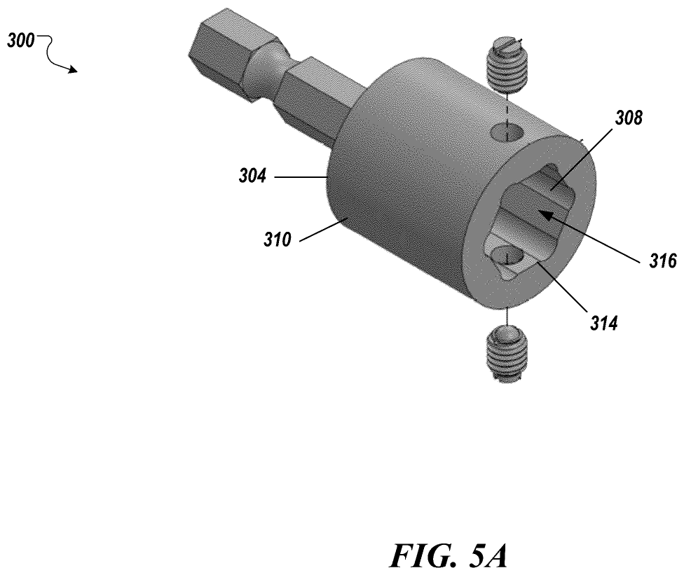

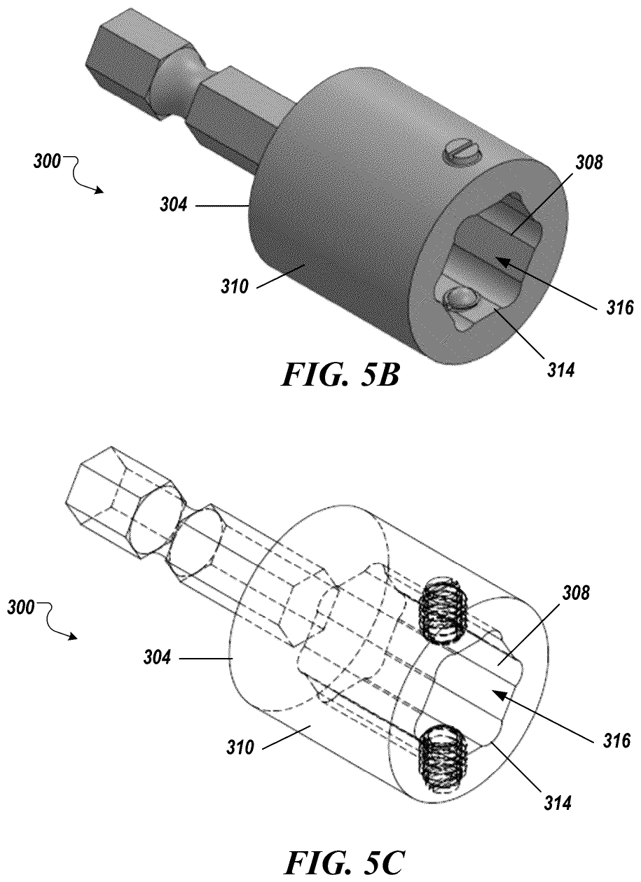

FIGS. 5A-5C show another implementation of a socket device 300. The socket device 300 is substantially similar to the socket device 200, except as described below. The cavity 316 defined by the inner surface 308 of the body 310 has a substantially hexagonal cross-sectional area. The cavity 316 extends from the first aperture 314 towards the second end 304 of the body 310. For example, the cavity 316 extends further than the cavity 216 of the socket device 200. The cavity 316 can accommodate long shafts and/or portions of fasteners, similar to the inner channel 226 of the socket device 200.

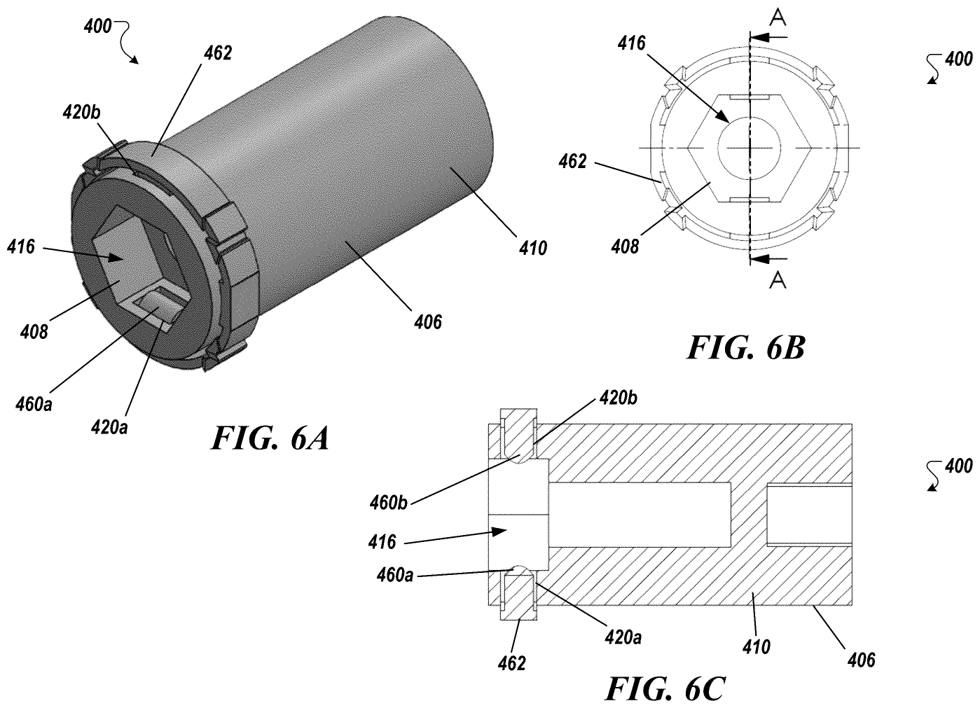

FIGS. 6A-6C show another implementation of a socket device 400. The socket device 400 is substantially similar to the socket device 100, except as described below. The body 410 of the socket device 400 defines a hexagonal cavity 416. The body 410 of the socket device 400 further defines a first channel 420a and a second channel 420b extending from the outer surface 406 to the inner surface 408 of the body 410.

The socket device 400 includes retainers extending through the first channel 420a and the second channel 420b. However, the retainers of the socket device 400 are external pressure tabs 460a and 460b. The pressure tabs 460a, 460b extend into the cavity 416 and are configured to retain the nut 10 therein, similar to the retainers of the socket device 100. However, the pressure tabs 460a, 460b extend from an outer ring 462 that extends around the outer surface 406 of the body 410. The outer ring 462 forms a spring that applies a radially inward bias on both pressure tabs 460a, 460b. The nut 10 is retained within the cavity 416 by the spring force applied by the pressure tabs 460a, 460b.

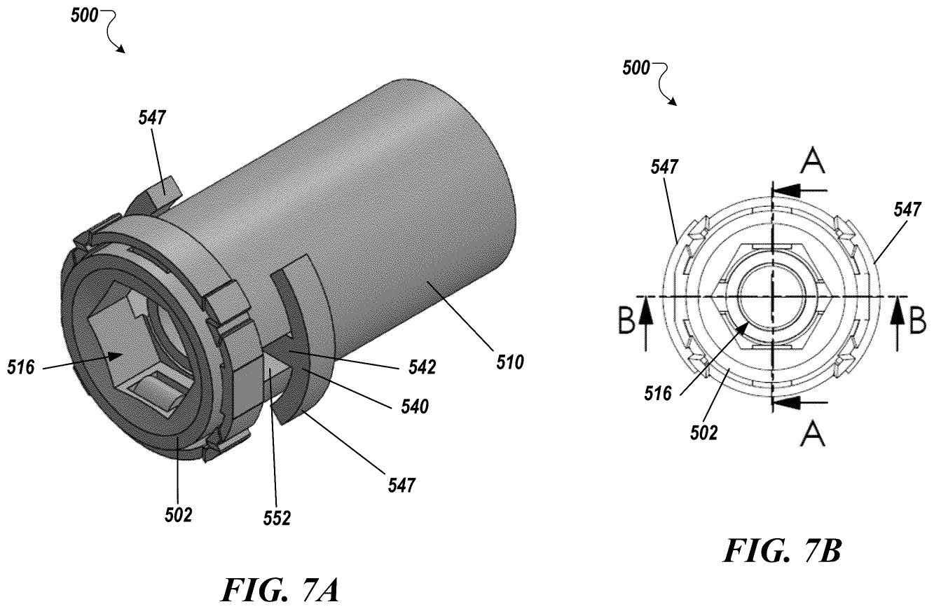

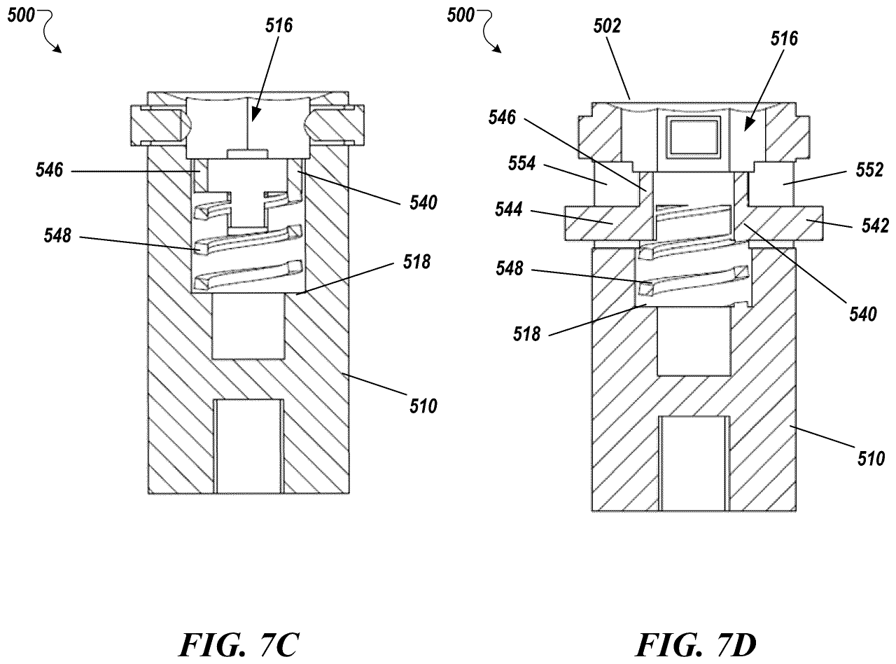

FIGS. 7A-7D show another implementation of a socket device 500. The socket device 500 is substantially similar to the socket device 400, except as described below. The body 510 of the socket device 500 defines a first longitudinal opening 552 and a second longitudinal opening 554, similar to the longitudinal openings 152, 154 of the socket device 100. The socket device 500 also includes an ejector 540, similar to the ejector 140 of the socket device 100. The ejector 540 is disposed within the cavity 516. A spring 548 is disposed between the end surface 518 of the cavity 516 and the central portion 546 of the ejector 540. The spring 548 resists motion of the ejector 540 towards the first end 502 of the body 510. Thus, a user or device engages the ejector 540 in a direction towards the first end 502 of the body 510 to eject a nut from the cavity 516.

Furthermore, the first rod 542 and the second rod 544 extending from the central portion 546 of the ejector 540 each include a circumferential extension 547 that extends perpendicularly from the respective rod 542, 544. The circumferential extension 547 provides a larger surface or material for engaging the ejector 540.

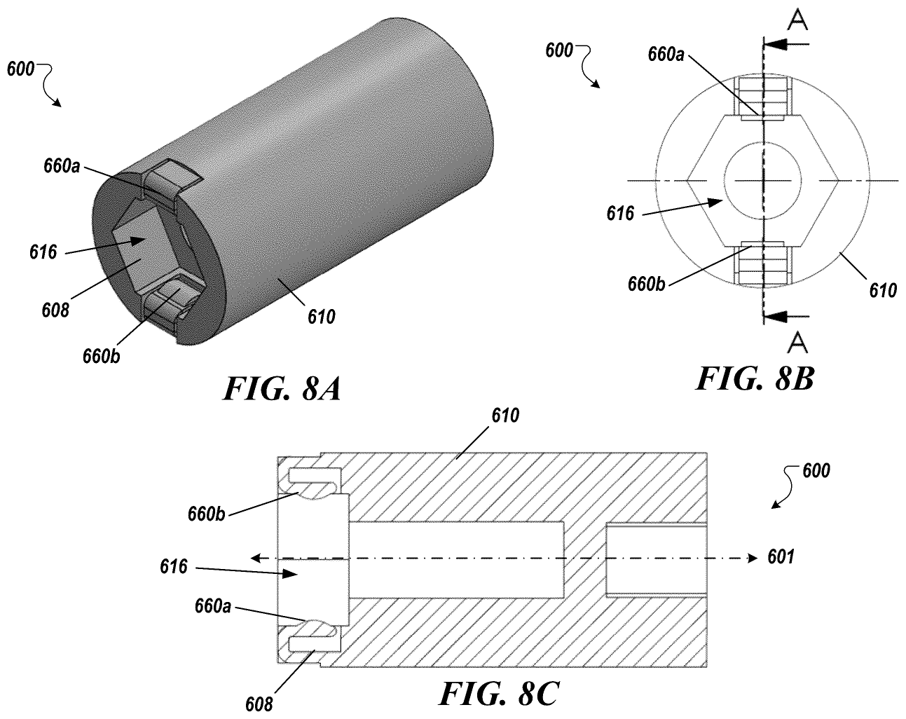

FIGS. 8A-8C show another implementation of a socket device 600. The socket device 600 is substantially similar to the socket device 100, except as described below. Instead of a perpendicular channel in the body 610 of the socket device 600, the socket device 600 includes internal pressure tabs 660a, 660b embedded within the body 610. Each of the internal pressure tabs 660a, 660b extends from a portion of the inner surface 608 of the body 610 within the cavity 616. The internal pressure tabs 660a, 660b extend in a direction substantially parallel to the longitudinal axis 601 and the inner surface 608 of the body 610. The internal pressure tabs 660a, 660b are cantilevered to form a spring-like tab biased radially inward towards the cavity 616.

The internal pressure tabs 660a, 660b are configured to retain a nut within the cavity 616. For example, the internal pressure tabs 660a, 660b may be deformed radially outward when a nut is inserted into the cavity 616. The radially inward bias of the internal pressure tabs 660a, 660b applies a force on the nut therein, retaining the nut within the cavity 616.

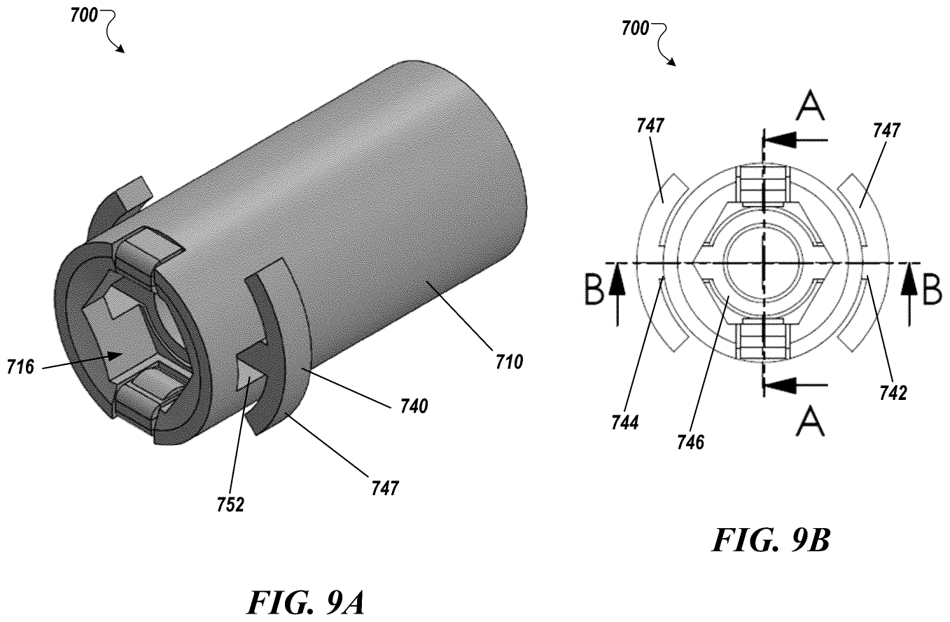

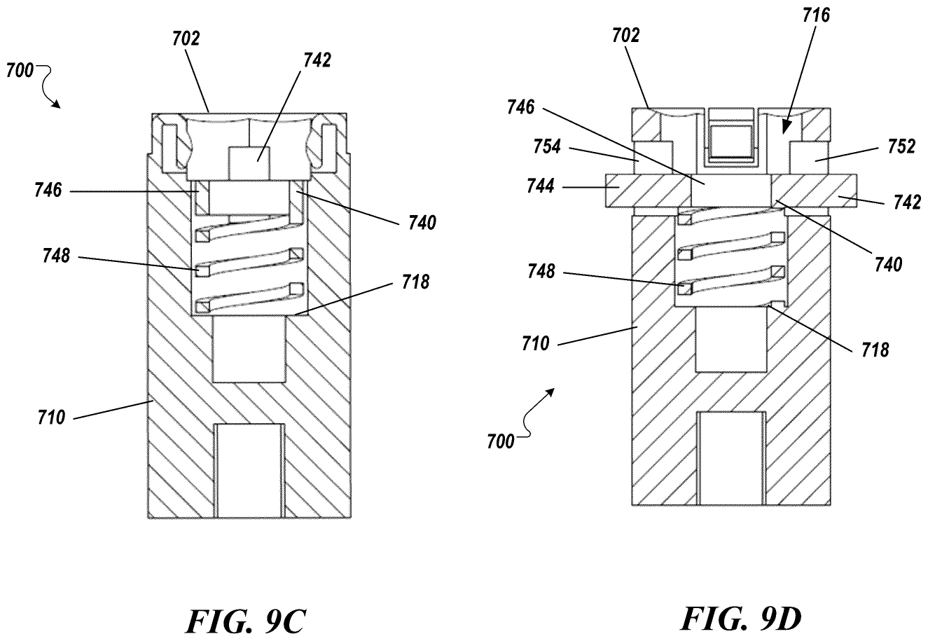

FIGS. 9A-9D show another implementation of a socket device 700, which is substantially similar to the socket device 600 except as described below. The body 710 of the socket device 700 defines a first longitudinal opening 752 and a second longitudinal opening 754, similar to the longitudinal openings 152, 154 of the socket device 100. The socket device 700 also includes an ejector 740, similar to the ejector 140 of the socket device 100. The ejector 740 is disposed within the cavity 716. A spring 748 is disposed between the end surface 718 of the cavity 716 and the central portion 746 of the ejector 740. The spring 748 resists motion of the ejector 740 towards the first end 702 of the body 710. Thus, a user or device engages the ejector 740 in a direction towards the first end 702 of the body 710 to eject a nut from the cavity 716.

Furthermore, the first rod 742 and the second rod 744 extending from the central portion 746 of the ejector 740 each include a circumferential extension 747 that extends perpendicularly from the respective rod 742, 744. The circumferential extension 747 provides a larger surface or material for engaging the ejector 740.

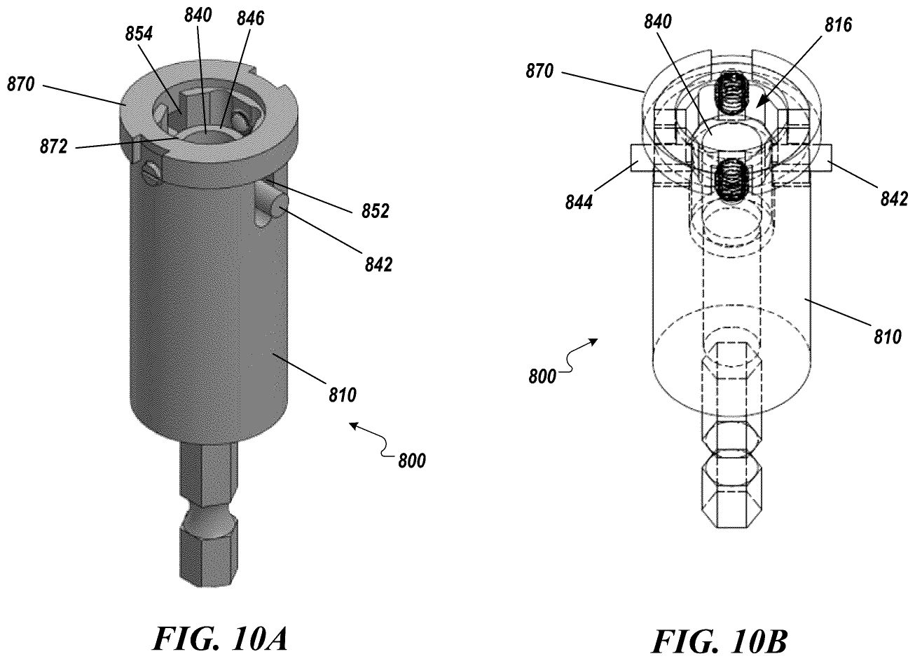

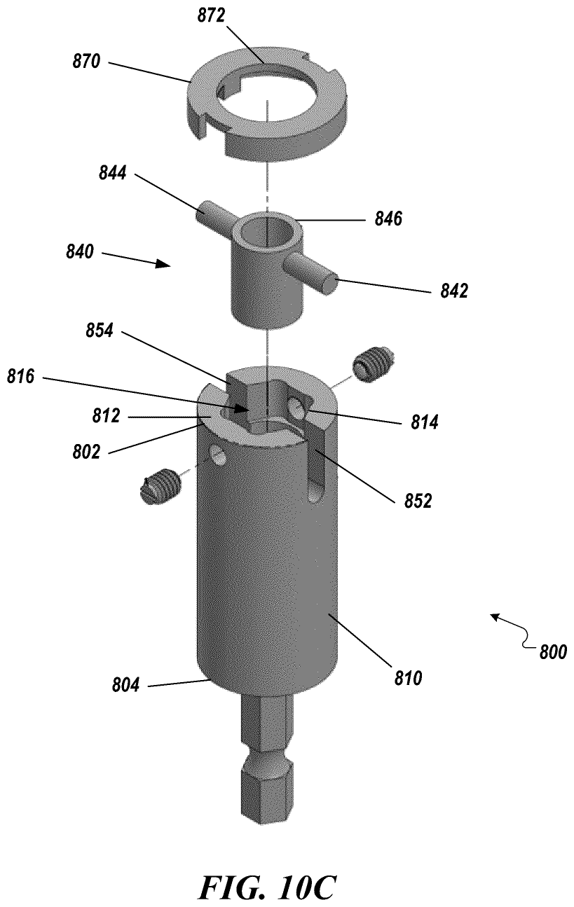

FIGS. 10A-10C show another implementation of a socket device 800. The socket device 800 is substantially similar to the socket device 100, except as described below. The body 810 of the socket device 800 defines a first longitudinal opening 852 and a second longitudinal opening 854, similar to the longitudinal openings 152, 154 of the socket device 100. However, the longitudinal openings 852, 854 extend to the first end 802 of the body 810 and the face 812 thereof. Thus, the longitudinal openings 852, 854 are more like slots that extend longitudinally along the body 810 from the first end 802 towards the second end 804. Thus, the first aperture 814 has a substantially hexagonal shape that is intersected by the longitudinal openings 852, 854.

The socket device 800 includes an ejector 840 having a central portion 846 with a first rod 842 and a second rod 844 extending therefrom. The ejector 840 sits within the cavity 816 and is moveable therein to eject the nut, similar to other ejectors described herein. The central portion 846 of the ejector 840 is cylindrical in shape. Specifically, the central portion 846 is a hollow cylinder moveable within the cavity 816. The ejector 840 may be referred to as a round ejector due to its shape.

To retain the ejector 840 within the cavity 816, the socket device 800 includes a cap 870. The cap 870 is coupled to the first end 802 of the body 810 to retain the ejector 840 within the cavity 816. For example, the cap 870 may be welded, friction fit, threaded, clipped, or otherwise coupled to the body 810. The cap 870 defines a central opening 872 large enough for the nut 10 to pass through. However, the ejector 840 and its associated rods 842, 844 cannot pass through the central opening 872.

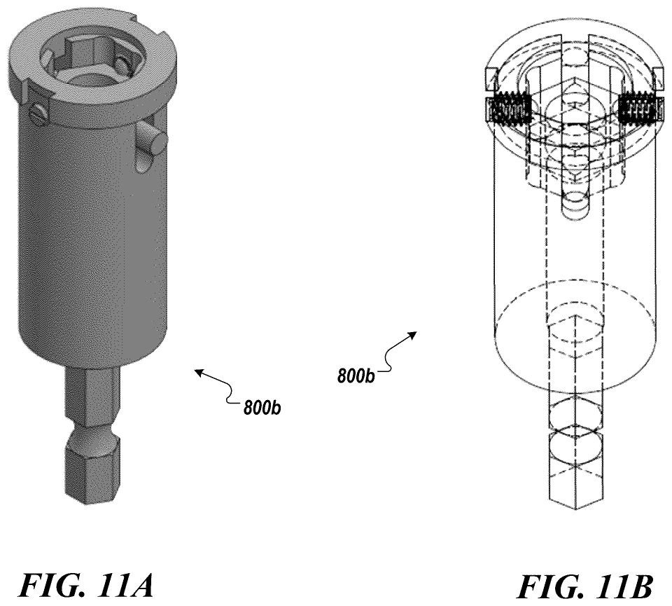

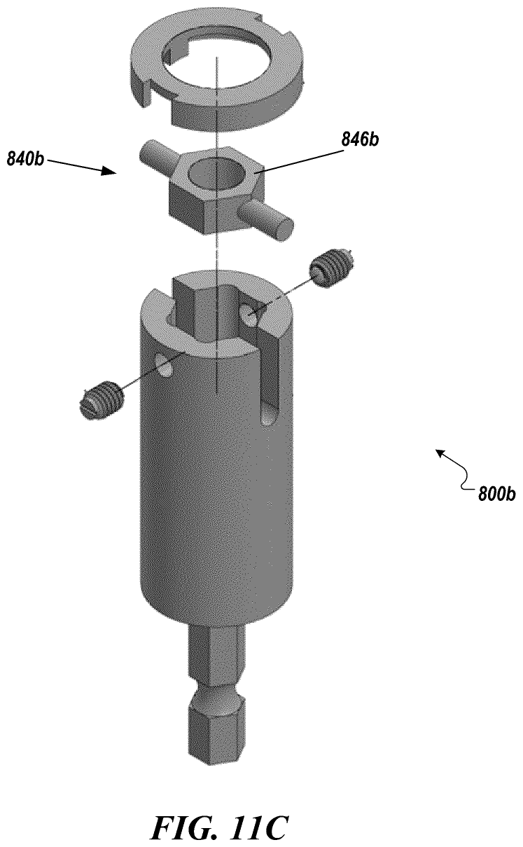

FIGS. 11A-11C show another implementation of a socket device 800, shown as 800b. The socket device 800b is substantially similar to the socket device 800, except for the ejector. As shown in FIG. 11C, the ejector 840b of the socket device 800b includes a hexagonally shaped central portion 846b. The ejector 840b may be referred to as a hexagon ejector due to its shape.

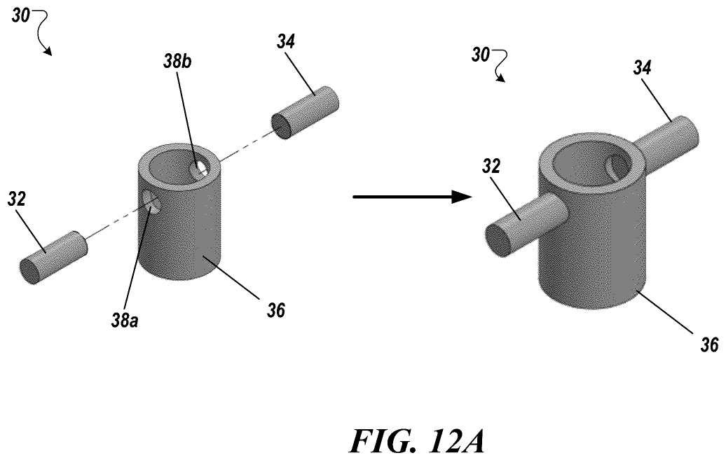

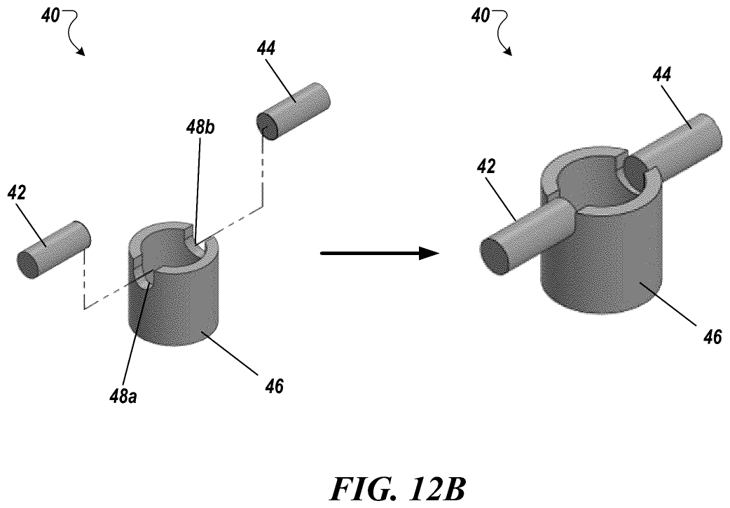

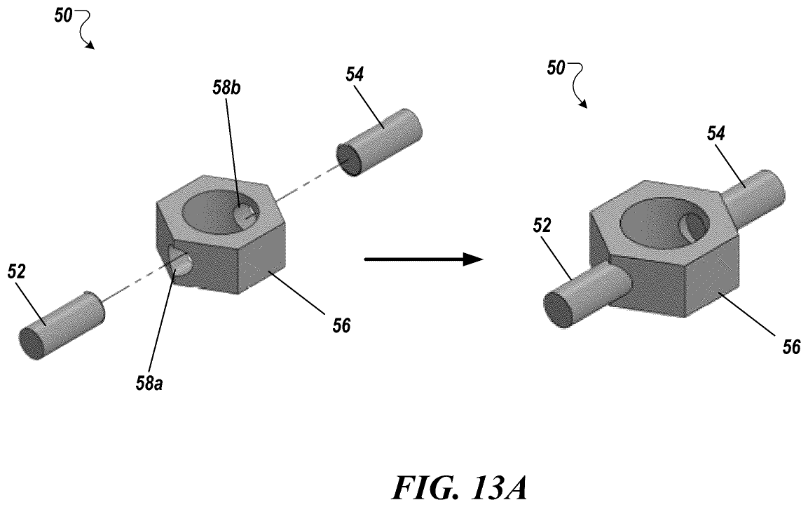

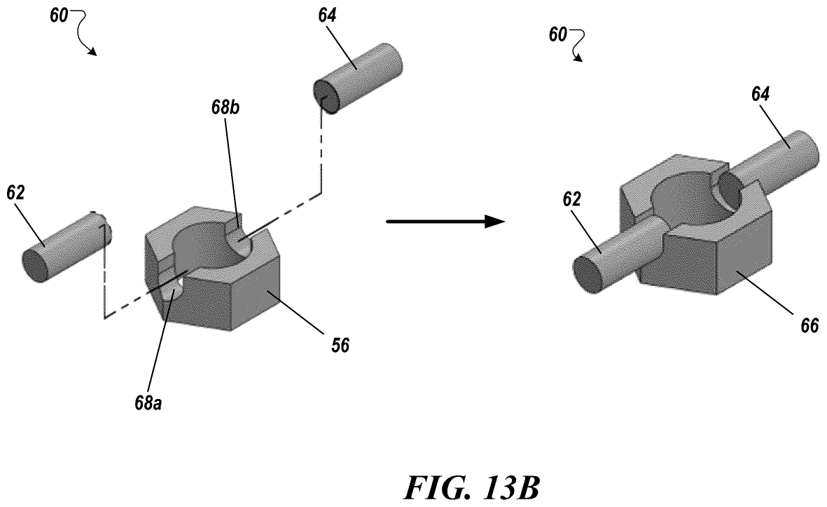

In general, the shapes and arrangements of the ejectors for the socket devices have various arrangements and optional features. Various combinations and implementations of these ejectors are contemplated by this disclosure. For example, FIGS. 12A-13B show different implementations of ejectors, any one or which may be implemented into the socket devices disclosed herein.

FIG. 12A shows a circular ejector 30, which is substantially similar to the ejector 840 of FIGS. 10A-10C. The ejector 30 includes a central portion 36 including a circular sidewall defining a central opening. Thus, the ejector 30 forms a hollow cylinder shape. The sidewall of the central portion 36 defines two openings 38a, 38b adjacent to but spaced apart from one end of the central portion 36. A first rod 32 is inserted into the opening 38a. A second rod 34 is inserted into the opening 38b. Thus, the first and second rods 32, 34 are coupled to the central portion 36. The coupling of the rods 32, 34 may be via threaded connection, friction fit, welding, glue, or any other suitable means.

FIG. 12B shows a circular ejector 40, which is substantially similar to the ejector 30 except as described below. Instead of openings in the sidewall of the central portion 46, the sidewall of the ejector 30 includes slots 48a, 48b. The slots 48a, 48b extend longitudinally from one end of the hollow cylinder and towards the other end. The rods 42, 44 may be coupled to the central portion 46 via the slots 48a, 48b.

FIG. 13A shows hexagonal ejector 50, which is substantially similar to the ejector 840b of FIGS. 11A-11C. The ejector 50 includes a central portion 56 including a hexagonal sidewall defining a circular central opening. The sidewall of the central portion 56 defines two openings 58a, 58b adjacent to but spaced apart from one end of the central portion 56. A first rod 52 is inserted into the opening 58a. A second rod 54 is inserted into the opening 58b. Thus, the first and second rods 52, 54 are coupled to the central portion 56. The coupling of the rods 52, 54 may be via threaded connection, friction fit, welding, glue, or any other suitable means.

FIG. 13B shows a hexagonal ejector 60, which is substantially similar to the ejector 50, except as described below. Instead of openings in the sidewall of the central portion 66, the sidewall of the ejector 60 includes slots 68a, 68b. The slots 68a, 68b extend longitudinally from one end of the ejector 60 and towards the other end. The rods 62, 64 may be coupled to the central portion 66 via the slots 68a, 68b. The features of the ejectors of FIGS. 12A-13B are exemplary only, and various other implementations, shapes, and combinations are contemplated by this disclosure.

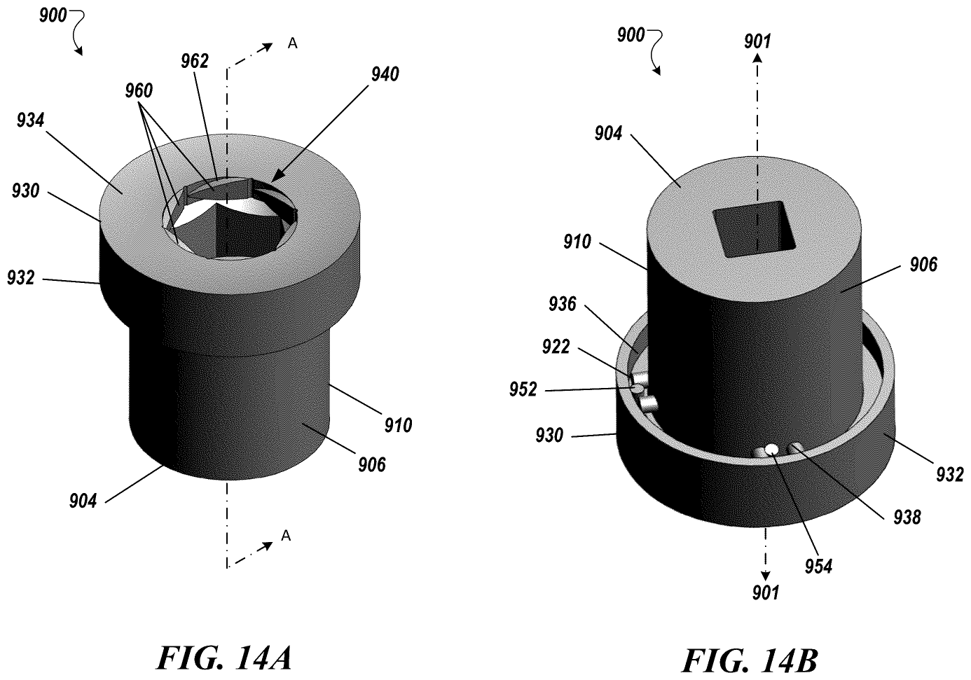

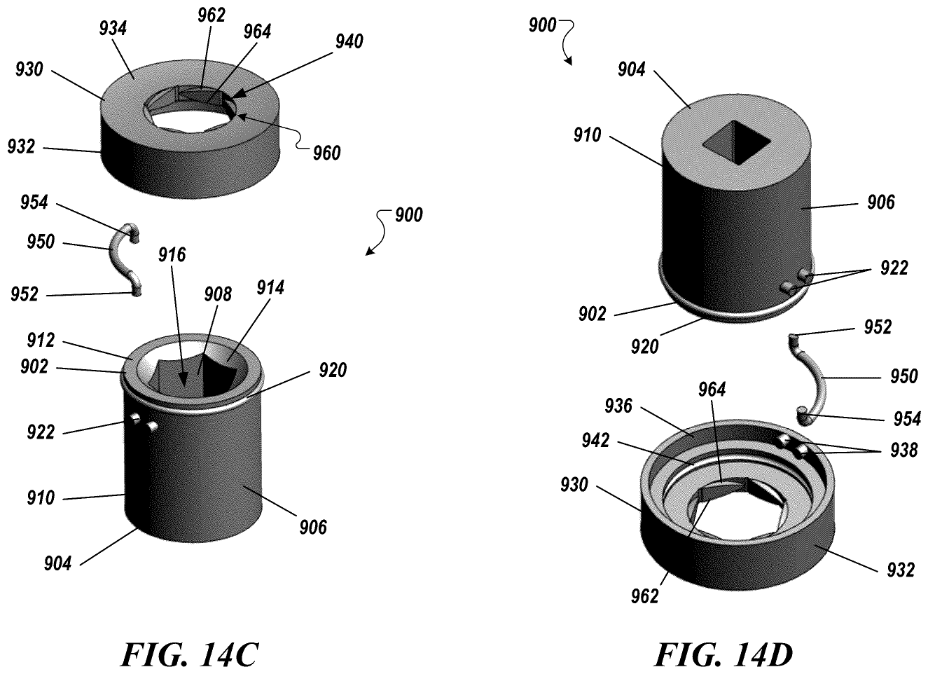

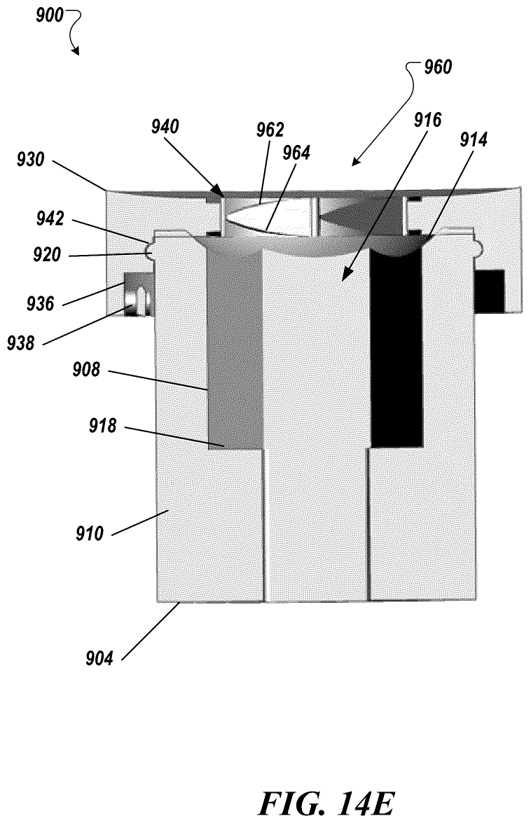

FIGS. 14A-14E show a socket device 900, according to another implementation. The socket device 900 provides a rotating cap portion which enables nut capture and ejection via application of longitudinal force (e.g., upon nut capture or installation on a fastener or device). The socket device 900 includes a body 910, a cap 930, and a spring 950 as further described below.

The socket device 900 includes a body 910 that extends from a first end 902 to a second end 904 opposite and spaced apart from the first end 902 along a longitudinal axis 901. The body 910 has a circular cross-sectional shape such that the body 910 is substantially cylindrical. The body 910 includes an outer surface 906 extending between the first end 902 and the second end 904. The body 910 further includes an inner surface 908 that is spaced apart radially inward from the outer surface 906 of the body 910. The first end 902 of the body 110 includes a face 912 that is substantially perpendicular to the outer surface 906, the inner surface 908, and the longitudinal axis 901. The first end 902 of the body 910 defines a first aperture 914. More particularly, the face 912 on the first end 902 of the body 910 defines the first aperture 914. Furthermore, the body 910 defines a cavity 916 extending longitudinally from the first aperture 914. More particularly, the cavity 916 is defined by the inner surface 908 of the body 910. The cavity 916 extends from the first aperture 914 to an end surface 918 extending perpendicularly to the face 912, the end surface 918 extending across the inner surface 908 to define an end of the cavity 916. The cavity 916 is configured to receive and retain a nut or a portion of a bolt, such as the nut 10.

The body 910 further includes a coupling ring 920 protruding radially outward from the outer surface 906. In particular, the coupling ring 920 is disposed adjacent to the first aperture 914, as shown in FIG. 14C. The coupling ring 920 extends around the entire outer surface 906 of the body 910. The coupling ring 920 is configured to engage with the cap 930 as further described herein.

The body 910 further includes a first coupler 922 or a first spring coupler 922. The first coupler 922 is shown in FIGS. 14C and 14D as two adjacent columnar protrusions extending from the outer surface 906. The protrusions of the first coupler 922 define a space therebetween to engage with and retain a portion or an end of the spring 950 as further described herein. However, in other implementations, the spring may be coupled to the body 910 by a different mechanism or structure.

The cap 930 is configured to couple to and freely rotate relative to the body 910. The cap 930 includes a sidewall 932 and an end surface 934. The sidewall 932 is a substantially cylindrical shape. The end surface 934 extends perpendicular to the sidewall 932, as shown in FIG. 14C. The end surface 934 defines a central aperture 940 having a shape substantially matching the shape of the first aperture 914 (e.g., circular or hexagonal). Specifically, the central aperture 940 is defined by a circular inner surface having a plurality of protrusions 960 extending therefrom, wherein the six protrusions 960 are arranged so that the central aperture 940 approximates a hexagon shape.

As shown in FIG. 14D, the sidewall 932 includes an inner surface 936. The inner surface 936 of the sidewall 932 includes a second coupler 938 or a second spring coupler 938. The second coupler 938 is shown in FIG. 14D as two adjacent columnar protrusions extending from the inner surface 936. The protrusions of the second coupler 938 define a space therebetween to engage with and retain a portion or an end of the spring 950 as further described herein. However, in other implementations, the spring may be coupled to the cap 930 by a different mechanism or structure.

The inner surface 936 of the sidewall 932 further includes a ring channel 942 extending circumferentially around the inner surface 936. The ring channel 942 is sized and configured to accept the coupling ring 920 of the body 910. Thus, when the body 910 is coupled to the cap 930, the cap 930 is freely rotatable relative to the body 910 via engagement of the ring channel 942 with the coupling ring 920. Engagement of the ring channel 942 with the coupling ring 920 also resists longitudinal motion of the cap 930 relative to the body 910.

The cap 930 further includes a plurality of protrusions 960 extending into the central aperture 940 of the cap 930. Each of the protrusions 960 are angled such that a nut 10 or other fastener being pushed into or out of the central aperture 940 engages the protrusions 960 to rotate the cap 930 relative to the body 910.

Each protrusion 960 includes a first surface 962 facing substantially away from the cavity 916. Each protrusion 960 includes a second surface 964 facing substantially towards the cavity 916, the second surface 964 being opposed to the first surface 962. The first and second surfaces 962, 964 are angled relative to the end surface 934. Furthermore, each set of first and second surfaces 962, 964 for each protrusion 960 are angled towards each other in a repeating pattern around the central aperture 940. For example, there are six protrusions 960 on the cap 930 to engage with a hexagonal nut or fastener. In other implementations, the protrusions may have a different number and/or arrangement matching a differently shaped fastener. In other implementations, the protrusions may have a different degree, proportion, or orientation of their relative angle.

The spring 950 is a torsional spring having a first end 952 and a second end 954. The first end 952 of the spring 950 is engaged with and retained by the first coupler 922 of the body 910. The second end 954 of the spring 950 is engaged with and retained by the second coupler 938 of the cap 930. However, in other implementations, a different type or shape of torsional spring is coupled between the cap and the body of the socket device.

The spring 950 is configured to bias the cap 930 to a certain position relative to the body 910 and resist rotational motion of the cap 930 relative to the body 910. Particularly, the spring 950 biases the cap 930—including the shape of the central aperture 940 and the associated protrusions 960—to a first position relative to the body 910. In the first position, the cap 930 and the central aperture 940 are misaligned relative to the first aperture 914 and the cavity 916 of the body 910. The cap 930 is rotatable relative to the body 910 from the first position, such rotation being resisted by the force of the spring 950.

In use, the socket device 900 may be coupled to a wrench, socket wrench, or other tool and used to retain and couple/uncouple a nut or other fastener from a bolt or other device/component. In use, a nut or a fastener (e.g., a nut 10) may be retained by the socket device 900 by (i) aligning the nut 10 with the longitudinal axis 901 of the socket device 900 and (ii) moving the socket device 900 towards the nut 10. The edges and/or faces of the nut 10 engage with the first surface 962 of the protrusions 960. Because the first surface 962 of the protrusions 960 are angled relative to the end surface 934 of the cap 930, the force imparted onto the cap 930 by the nut 10 causes the cap 930 to rotate relative to the body 910.

The cap 930 rotates relative to the body 910 against the force of the spring 950 until the first aperture 914 of the body 910 aligns with the central aperture 940 of the cap 930. This position may be defined as the aligned position of the cap 930 and the body 910, as opposed to the initial, misaligned position. For example, once the hexagonally shaped central aperture 940 is aligned with the hexagonally shaped first aperture 914, the hexagonally shaped nut 10 can enter into the cavity 916 of the body 910. Once the nut 10 passes by the protrusions 960 and enters the cavity 916, the cap 930 is rotated back to the initial, misaligned position by the force of the spring 950.

Once the nut is retained in the body 910, the socket device 900 can be moved and engaged with a bolt or other fastener configured to accept and engage with the nut 10. Once the nut 10 is engaged with the bolt or other fastener, the socket device 900 can be pulled away from the nut 10 to remove the nut 10 from the cavity 916. As the socket device 900 is moved away from the nut 10 and the corresponding bolt or fastener coupled thereto, the edges and/or faces of the nut 10 engage with the second surface 964 of the protrusions 960. Because the second surface 964 of the protrusions 960 are angled relative to the end surface 934 of the cap 930, the force imparted onto the cap 930 by the nut 10 causes the cap 930 to rotate relative to the body 910. The cap 930 rotates against the force of the spring 950 until the cap 930 and the body 910 again reaches the aligned position. In the aligned position, the socket device 900 is disengaged from the nut.

Therefore, the socket device 900 provides an automatic engaging/disengaging socket that retains a nut therein. In other implementations, the socket device 900 may include an ejector (such as those elsewhere described herein) to facilitate removal of a retained nut.

### Conclusion

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as”is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. A socket device comprising:
a body comprising a first end and a second end opposite and spaced apart from the first end along a longitudinal axis, the body defining a first aperture on the first end and a cavity at least partially defined by an inner surface of the body that extends from the first aperture, the cavity being configured to receive a nut or bolt;
a first channel defined by the body adjacent to the first end of the body, the first channel extending between the inner surface and an outer surface of the body in a direction substantially perpendicular to the longitudinal axis of the body; and
a first retainer disposed within the first channel defined by the body, the first retainer comprising a first end adjacent to the inner surface of the body, the first end of the first retainer being biased radially inward towards the cavity, wherein the first retainer is moveable between:
(i) a first position wherein the first end of the first retainer extends into the cavity to retain the nut or bolt within the cavity; and
(ii) a second position wherein the first end of the first retainer retracts radially outward to release the nut or bolt from the cavity.

2. The socket device of claim 1, wherein the second end of the body is couplable to a wrench.

3. The socket device of claim 1, wherein the socket device has a form of a wrench.

4. The socket device of claim 1, wherein the first retainer is a spring plunger.

5. The socket device of claim 1, wherein the first retainer is a pressure tab extending into the cavity from a portion of the body and cantilevered therefrom.

6. The socket device of claim 1, wherein the first retainer is a plunger, the socket further comprising a circumferential spring extending around the outer surface of the body and coupled to a second end of the plunger to bias the plunger radially inwards.

7. The socket device of claim 1, wherein the first end of the first retainer comprises an outer surface having one of a bull-nose shape, a polygonal shape, or a flat shape.

8. The socket device of claim 1, further comprising:
a second channel defined by the body adjacent to the first end of the body and spaced apart circumferentially from the first channel, the second channel extending between the inner surface and the outer surface of the body in a direction substantially perpendicular to the longitudinal axis of the body; and
a second retainer disposed within the second channel defined by the body, the second retainer comprising a first end adjacent to the inner surface of the body, the first end of the second retainer being biased radially inward towards the cavity, wherein the second retainer is moveable between:
(i) a first position wherein the first end of the second retainer extends into the cavity to retain the nut or bolt within the cavity; and
(ii) a second position wherein the first end of the second retainer retracts radially outward to release the nut or bolt from the cavity.

9. The socket device of claim 7, wherein the first and second retainers are diametrically opposed across the cavity.

10. The socket device of claim 1, wherein the first aperture has a hexagonal shape corresponding to a hexagonal cross-sectional shape of the cavity.

11. The socket device of claim 1, wherein a cross-sectional shape of the cavity is round, rectangular, triangular, or hexagonal.

12. The socket device of claim 1, further comprising:
an ejector disposed within the cavity adjacent to a second end of the cavity opposite from the first aperture, the ejector comprising a first rod coupled to and extending from the ejector, the first rod extending through a first longitudinal opening defined between the inner surface and the outer surface of the body,
wherein the ejector is moveable towards the first end of the body to eject a nut or bolt retained in the cavity by the first retainer.

13. The socket device of claim 12, the ejector further comprising a second rod coupled to and extending from the ejector, the second rod being circumferentially spaced apart form the first rod, the second rod extending through a second longitudinal opening defined between the inner surface and the outer surface of the body.

14. The socket device of claim 12, the ejector further comprising a spring disposed within the cavity and coupled to the ejector, the spring configured to bias the ejector toward the second end of the body, wherein a force is applied to the first rod to move the ejector towards the first end of the body and eject the nut or bolt.

15. The socket device of claim 12, further comprising: a cap coupled to the first end of the body to retain the ejector within the cavity.

16. A socket device comprising:
a body comprising a first end and a second end opposite and spaced apart from the first end along a longitudinal axis, the body defining a first aperture on the first end and a cavity at least partially defined by an inner surface of the body that extends from the first aperture, the cavity being configured to receive a nut or bolt, the body further comprising a first coupler extending from an outer surface of the body;
a cap coupled to and freely rotatable about the body, the cap comprising:
a sidewall extending around the outer surface of the body, wherein a second coupler extends from an inner surface of the sidewall;
an end surface defining a central aperture having a shape matching the first aperture of the body; and
a plurality of protrusions extending into the central aperture, each of the plurality of protrusions comprising a first surface and a second surface that are each sloped towards each other and angled relative to the end surface; and
a torsional spring coupled between the first coupler of the body and the second coupler of the cap,
wherein the cap is biased by the torsional spring towards a offset position wherein the central aperture of the cap is misaligned with the first aperture and the cavity of the body,
wherein, when a force is applied between a nut or bolt and the angled first surfaces of the plurality of protrusions enables rotation of the cap relative to the body until (i) the central aperture of the cap aligns with the first aperture of the body, and (ii) the nut or bolt is retained within the cavity of the body.

17. The socket device of claim 16, wherein a force applied between the nut or bolt and the angled second surface of the plurality of protrusions enables rotation of the cap relative to the body until (i) the central aperture of the cap aligns with the first aperture of the body, and (ii) the nut or bolt is released from within the cavity of the body.

18. The socket device of claim 16, wherein the second end of the body is couplable to a wrench.

19. The socket device of claim 16, wherein a cross-sectional shape of the cavity is round, rectangular, triangular, or hexagonal.

20. The socket device of claim 16, wherein the outer surface of the body comprises a circumferential protrusion that is couplable with a ring channel defined by the inner surface of the sidewall of the cap, enabling rotation of the body relative to the cap.
